(19) United States
(12) Patent Application Publication
(10) Pub. No.: US 2006/0102235 A1
(43) Pub. Date: May 18, 2006

(54) Integratable sanitary part

(75) Inventor: Martin Fangmeier, Auggen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Neoperl GmbH, Mullheim (DE)

(21) Appl. No.: 11/319,115

(22) Filed: Dec. 27, 2005

Related U.S. Application Data
(63) Continuation-in-part of application No. 10/495,420, filed on May 13, 2004.

(30) Foreign Application Priority Data
Nov. 17, 2001 (DE) 201 18 810.4

(51) Int. Cl. F16K 15/06

(52) U.S. Cl. 137/540

(57) ABSTRACT

An interchangeable sanitary part in the form of a check valve including an outer housing (3) which can be inserted into a fluid line and has at least one peripheral seal (20, 21) on its outer circumference, which seals the outer housing (3) and the fluid line against each other. In order to avoid using additional O-rings, the at least one seal (20, 21) for providing linear or planar sealing is produced from the same material as the outer housing and forms a single element with the outer circumference of the housing. A least one peripheral sealing lip (8) located on the inner surface of the outer housing (3) is provided which is formed of the same material as the outer housing. The free end of the sealing lip (8) protrudes in such a way that, when the check valve is closed, the lip acts on the closing part (4) or the inner surface of the outer housing (3) in a sealing manner.

### CROSS-REFERENCE TO RELATED APPLICATIONS

This application is a continuation-in-part of U.S. application Ser. No. 10/495,420, filed May 13, 2005, which is a 371 national phase of PCT/EP02/12827, filed Nov. 15, 2002. Foreign priority is claimed from DE 201 18 810.4, filed Nov. 17, 2001, all of which are incorporated herein by reference as if fully set forth.

### BACKGROUND

The invention relates to an integratable sanitary part with an outer housing, which can be inserted into a fluid line and which carries on the outer circumference of the housing at least one peripheral seal, which seals the outer housing and the fluid line with each other.

From DE 37 22 665 C2, a check valve is already known, which has a closing part, which can be moved against a valve seat in the outer housing of this check valve against the direction of flow. In order to tightly seal the region between the valve seat and the closing part in the closed position of the known check valve, an O-ring made from elastic material is inserted into a groove on the closing part. The outer housing of the known check valve carries another O-ring made from elastic material, which should seal the outer housing and the adjacent fluid line with each other.

If such check valves are inserted into sanitary water lines, special certifications are required, which certify that the components are of a quality, e.g., suitable for carrying food. Because many elastomers contain a high percentage of softeners, only a limited selection of elastomers are available for manufacturing the O-ring used in known check valves. In addition, the manufacturing of such check valves also requires a greater expense due to the use of several components made from different materials.

### SUMMARY

Therefore, there is the object of creating an integratable sanitary part of the type mentioned in the introduction, which can be produced with low expense and can be used for multiple purposes.

More specifically, the solution of this objective according to the invention for the integratable sanitary part of the type mentioned in the introduction is to form the one or more seals provided for linear and/or planar sealing on the outer circumference of the housing as an integral piece.

The integratable part according to the invention has an outer housing that can be inserted into a fluid line, on whose housing outer circumference at least one peripheral seal is formed as an integral piece, which is used for linear and/or planar sealing between the outer housing and fluid line. This seal makes an additional O-ring made from elastic material unnecessary. By eliminating such an O-ring, the cost associated with production and if applicable, also the certification of such an integratable part can be reduced considerably, especially if the sealing is likewise produced from the material also used for the outer housing.

In this way, for one embodiment according to the invention, at least one seal is formed as a lip seal. In addition or as an alternative, it can be advantageous if at least one seal is configured as a sealing ring formed on the outer housing.

In order to achieve a load-capable seal between the outer housing and fluid line also for high fluid pressures, it is advantageous if several lip seals and/or sealing rings are formed as integral pieces on the outer housing, which can be arranged with sufficient distance from each other in the intended direction of flow.

Here, it can be advantageous if the seal(s) are provided in the supply end region or in a center region of the outer housing.

In order to be able to arrange the outer housing with a force-fit seating in the fluid line and in order to be able to press the seal securely and tightly to the fluid line, it is advantageous if the outer housing has a barrel-shaped or bulging outer outline, at least in part of the peripheral region. In this way, it can be advantageous if the greatest outer extent of the bulging outer housing is arranged somewhat in the middle, relative to the longitudinal extent of the housing, and/or if in the region of the greatest outer extent of the bulging outer housing, there is at least one sealing ring, preferably at least two sealing rings.

In another solution according to the invention for the objective stated in the introduction, which is worthy of protection in its own right, and which relates to an integratable part configured as a sanitary check valve, at least one peripheral sealing lip is formed as an integral piece on the inner surface of the outer housing or on the closing part, wherein this sealing lip projects with its free lip end such that in the closed position of the check valve, the lip end forms a seal on the closing part or the inner surface of the outer housing.

This check valve according to the invention, whose outer housing and closing part are formed as plastic injection-molded parts made from thermoplastic or a similar technical plastic, has at least one sealing lip, which is formed on the inner surface of the outer housing or on the closing part as an integral piece. Because these one or more sealing lips are configured as a formation on the outer housing or the closing part, they can also be produced from the same material. Such a sealing lip, which forms a seal in the closed position of the check valve with the closing part or the inner surface, likewise makes an additional O-ring made from elastic material unnecessary. By eliminating this O-ring, the expense associated with the production and, if applicable, the certification of such a check valve can be reduced considerably.

For an embodiment, in which at least one peripheral sealing lip is provided on the closing part, it is advantageous if a sleeve-shaped housing section with a central flow-through opening is provided in the outer housing, wherein this sleeve-shaped housing section has a truncated cone-shaped outer extent at least in a sleeve-end region projecting into the housing interior and forming the valve seat, and if the lip end of the one or more sealing lips formed on the closing part forms a seal on the truncated cone-shaped outer extent of the sleeve-shaped housing section in the closed position of the check valve. For this refinement according to the invention, the sealing lip widens slightly when it contacts the truncated cone-shaped outer extent of the sleeve-shaped housing section and does not compress in the outer extent, which could alternatively lead to the formation of a fold in the region of the sealing lip and thus to an undesired break in the seal.

To prevent undesired leakage and similar seal failure in the closed position of the check valve, it is advantageous if the one or more sealing lips form a peripheral, linear contact against the closing part or the inner surface of the outer housing in the closed position of the check valve with its free lip end region.

In one embodiment according to the invention, the one or more sealing lips extend to form a conical point in cross section in their free lip end region.

An especially good seal of the valve seat can be achieved if the one or more sealing lips is/are oriented in their longitudinal extent approximately parallel to the longitudinal axis of the check valve. In this way, it is especially advantageous if the partial region of the closing part contacted by the sealing lip is formed as an inclined surface oriented in the flow-through direction from inside to outside. Especially through the combination of these features, the one or more sealing lips form a seal with the closing part inclined to the surface of the closing part.

To counteract over-extension of the sealing lip in the closed position of the check valve and to achieve high return-pressure stability, it is advantageous if the check valve has at least one stop for the closing part engaged in this closed position.

It is advantageous if an annular, peripheral partial region of the inner surface of the outer housing is provided as a stop. The sleeve-end region of the sleeve-shaped housing section forming a valve seat in the outer housing of the check valve can be used, e.g., as the stop.

In the closed position of the check valve, an additional seal can be achieved if the inner surface of the outer housing is formed complementary to the opposite partial region of the closing part in the closed position in its annular, peripheral partial region acting as a stop.

In this way, in a preferred embodiment according to the invention, the one or more sealing lips and the one or more stops are arranged so that the sealing lips contact the closing part before the stop is engaged.

It can be advantageous if the one or more sealing lips are formed flexible and elastic at least in their free lip end region. The closing and returning movements of these sealing lips, which are flexible and elastic at least in one partial region, counteracts calcification of the check valve at least in this region.

To achieve a self-reinforcing sealing effect of the sealing lip, it can be advantageous if a return flow acts on at least one sealing lip, which can be pressed against the closing part.

A high fatigue strength of the check valve can be supported if the outer housing is produced from a plastic, preferably a structural plastic.

In this way, in a preferred embodiment according to the invention, the outer housing is produced from a thermoplastic material.

Obtaining the necessary certifications, e.g., for use in sanitary installations, can be simplified and the manufacturing expense reduced if the outer housing and the closing part are produced from the same material.

### BRIEF DESCRIPTION OF THE DRAWINGS

Further features of the invention are found in the following description of preferred embodiments according to the invention in connection with the claims and also the drawing. The individual features can be utilized alone or in combinations to form an embodiment according to the invention.

Shown are:

FIG. 1 is a view of a check valve, which has on the inner surface of the outer housing a peripheral sealing lip, which forms a seal in the closed position of the check valve on the closing part, and

FIG. 2 is a view of a check valve also shown in a longitudinal section, which here has on its closing part at the end a peripheral sealing lip, which interacts with the outer truncated cone-shaped sleeve-end region of a sleeve-shaped section of the outer housing forming the valve seat.

FIG. 3 is a view of a check valve shown in longitudinal section, which has a peripheral sealing lip on an inner surface of the outer housing similar to FIG. 1, which forms a seal in a closed position of the check valve, and includes integrated peripheral seals on an outer peripheral surface of the outer housing, similar to FIG. 2, for sealing against an inner surface of a fluid line.

### DETAILED DESCRIPTION OF THE PREFERRED EMBODIMENTS

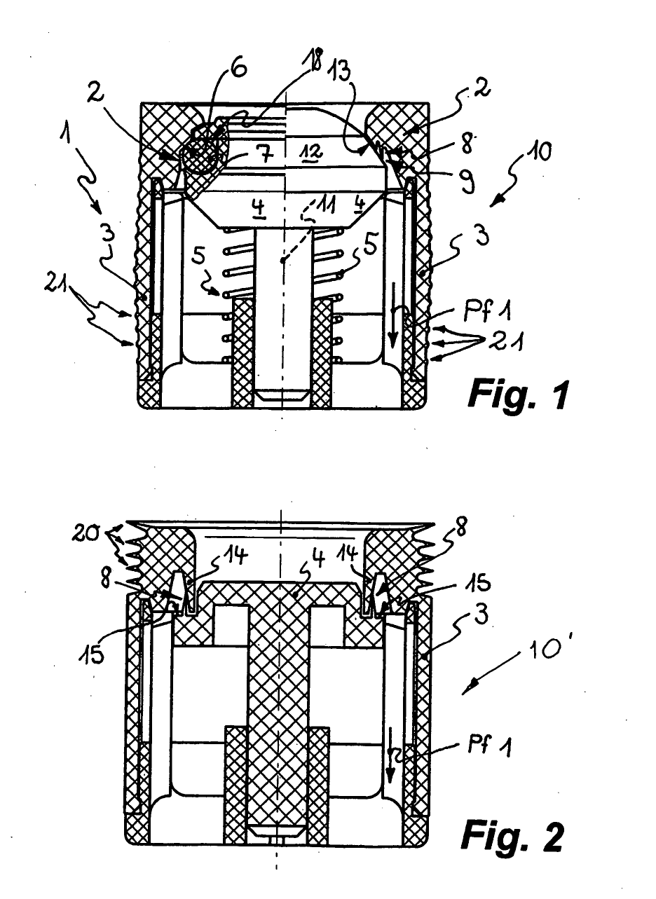

In FIG. 1, two different configurations 1, 10 of a check valve are shown in a longitudinal section. While the configuration shown in the left half of FIG. 1 documents the inner structure of the state of the art, an embodiment of the check valve 10 according to the invention is shown in the right half of FIG. 1.

The check valves 1, 10 shown in FIG. 1 are designed to be inserted into a sanitary water line. They feature a valve 2, which is arranged in a sleeve-shaped outer housing 3. The valve 2 of the check valve 1, 10 has a closing part 4, which can be moved in the outer housing 3 by the restoring force of a compression spring 5 against the flow-through direction Pf1 against a valve seat 6. In this way, the valve seat 6 is formed by a partial region of the inner surface of the outer housing 3.

As can be seen from the left side of FIG. 1, the known check valve 1 internal structure has an O-ring made from elastic material, which is inserted into a groove 18 on the closing part 4. Because many elastomers are not suitable for drinking water due to a high percentage of softeners, for various applications, at best only a limited selection of elastomers are available for producing such O-rings. Because the elastic material of the O-rings 7 tends to stick to the valve seat 6 at first, especially after a corresponding contact pressure, the known check valves 1 do not exhibit uniform response behavior for opening and closing. In addition, the known check valves 1 show increased wear and tear in the region of the O-ring 7.

Therefore, instead of an O-ring 7, the check valve 10 according to the invention has a peripheral sealing lip 8, which is formed as an integral piece in the region of the valve seat 6 on the inner surface of the outer housing 3. This sealing lip 8 projects with its free lip end 9 into the housing interior such that it forms a seal on the closing part 4 in the closed position of the check valve 10. The sealing lip 8 is here formed as a pointed lip and extends to a conical point in cross section on its free lip end region. This pointed configuration of the sealing lip 8 guarantees that the sealing lip 8 of the closing part forms a peripheral, linear contact in the closed position of the check valve 10 with its free lip end region.

The sealing lip 8 oriented in its longitudinal extent with its axis approximately parallel to the longitudinal axis 11 of the check valve 10 contacts the closing part 4 in its partial region 12, which is formed as an inclined surface arranged in the flow-through direction Pf1 from inside to outside.

To counteract over-extension of the sealing lip 8 and to achieve a high return-pressure stability of the check valve 10, the check valve 10 has a stop 13, which is here formed by an annular, peripheral partial region of the inner surface of the outer housing 3.

In this way, the partial region of the surface acting as the stop 13 is formed complementary to the opposite partial region of the closing part 4 in the closed position. Because the stop 13 contacts the inclined surface 12 of the closing part 4 in the closed position of the check valve 10, an additional seal can be achieved in this region of the check valve 10.

So that the stop 13 can be engaged only for a defined pressure of the return flow, the sealing lip 8 is arranged in the flow-through direction Pf1 before the stop 13 such that the sealing lip 8 contacts the closing part 4 before the stop 13 is engaged.

The sealing lip 8 is here configured to be flexible and elastic only in its free lip end region. The closing and returning movements of the flexible and elastic partial region of the sealing lip 8 effectively counteracts calcification of the check valve 10 in this region. The sealing lip 8 projects into the housing interior such that it is charged by a return flow and is pressed against the closing part 4. The valve 2 of the check valve 10 thus has a self-reinforcing sealing function.

Because the sealing lip 8 of the check valve 10 is configured as a formation of the outer housing 3, it can also be produced from the same material. The sealing lip 8, which in the closed position of the check valve 10 forms a seal on the closing part 4, makes an additional O-ring made from elastic material unnecessary. By eliminating the O-ring, the expense associated with the production and, if applicable, also the certification of such a check valve can be reduced considerably.

In this way, it is advantageous if the outer housing 3 with the sealing lip 8 formed thereon and the closing part 4 are produced from the same material. In the embodiment shown here, the components 3, 4 of the check valve 10 are produced from a technical thermoplastic or a similar structural plastic, which is here designated generally as thermoplastic.

In order to be able to also form a good seal for intermediate spaces possibly remaining between the check valve 10 and the adjacent flow line and in order not to also provide an elastic O-ring in this region, in the embodiments described here, on the outside of the outer housing of the check valve, at least one seal is formed from the same material and as an integral piece. The check valve 10 according to the invention can be produced with low expense from only a few components, preferably from the same material, wherein, e.g., the outer housing and the closing part can be produced in a very simple way as plastic injection-molded parts.

FIG. 2 shows a different embodiment of the check valve 10′ according to the invention. The check valve shown in FIG. 2 has on the supply end of its closing part 4 a peripheral sealing lip 8 projecting in the longitudinal direction of the check valve 10′. In the closed position of the check valve 10′, the sealing lip 8 contacts the inner surface of the outer housing 3 to form a linear seal. For this purpose, in the outer housing 3, a sleeve-shaped housing section 14 is provided, which has a truncated cone-shaped outer extent in its sleeve end region projecting into the housing interior and forming the valve seat. During the closing movement of the check valve 10′, if the sealing lip 8 contacts the truncated cone-shaped housing section 14, the one or more sealing lips 8, which are flexible and elastic at least in their free lip end region, widen slightly and do not compress in their outer extent, which could alternatively lead to the formation of a fold in the region of the sealing lip 8 and thus to undesired breaks in the seal.

The sealing lip 8 of the check valve 10′ shown in FIG. 2 is also oriented in its longitudinal extent approximately axis parallel to the longitudinal axis of the check valve 10′ and extends into a conical point in cross section in its free lip end region.

In FIG. 2, it can be seen that the end of the truncated cone-shaped housing section 14 forming the valve seat acts as a stop for the closing part 4, which is engaged in the closed position. In this way, the front end of the housing section 14 interacts with an annular shoulder 15, which is oriented approximately perpendicular to the longitudinal axis of the check valve 10′ and which is provided on the outer edge of the supply end of the closing part 4 and which carries the sealing lip 8. The sealing lip 8 and the front end of the housing section 14 acting as a stop for the closing part 4 are arranged so that the sealing lip 8 contacts the closing part 4 before the front end of the housing section 14 contacts the annular shoulder 15 of the closing part 4.

The check valve 10′ shown in FIG. 2 otherwise corresponds to the embodiment 10 shown in FIG. 1. The check valve shown in FIG. 2 can also eliminate an O-ring made from elastic material in the region of the valve seat, which considerably reduces the expense associated with production and also certification of such a check valve.

It is made clear from FIGS. 1 and 2 that the integratable sanitary parts 10, 10′ shown here can also be sealed in the region between their outer housing 3 and the fluid line without an additional separate O-ring made from elastic material. The integratable sanitary parts 10, 10′ which are here configured as check valves, have peripheral seals 20, 21 for this purpose, which are formed as an integral piece on the outer circumference of the housing. These seals 20, 21 configured as formations of the outer housing 3 are produced from the same material as the outer housing 3.

The seals 20, 21 of the check valve are arranged at a slight distance from each other in the supply direction Pf1 and here each provide for a linear seal between the outer housing 3 and fluid line.

In FIG. 2 it can be seen that the seals of the check valve 10′ are configured as lips seals 20, which are arranged in the supply end region of the check valve. While the upper sealing lip 20 forming the supply end of the check valve is oriented diagonally against the supply direction Pf1, the subsequent sealing lips 20 in the supply direction Pf1 are oriented somewhat in the radial direction.

In contrast, the check valve 10 shown in FIG. 1 has in the center region of its longitudinal extent several seals 21, which are formed as peripheral sealing rings 21 on the outer housing 3 as integral pieces. To press the sealing rings 21 tightly against the fluid line, the check valve 1 has a bulging outer outline in this center region, whose greatest outer diameter is preferably approximately equal to or greater than the inner diameter of the fluid line in the line section designed for holding the check valve.

The seals 20, 21 of the check valve 10, 10′ make an additional O-ring made from elastic material on the outer housing 3 unnecessary. By eliminating such an O-ring, the expense associated with production and, if applicable, certification of such an integratable part can be reduced significantly, especially if the seals 20, 21 are likewise produced from the material used for the outer housing 3.

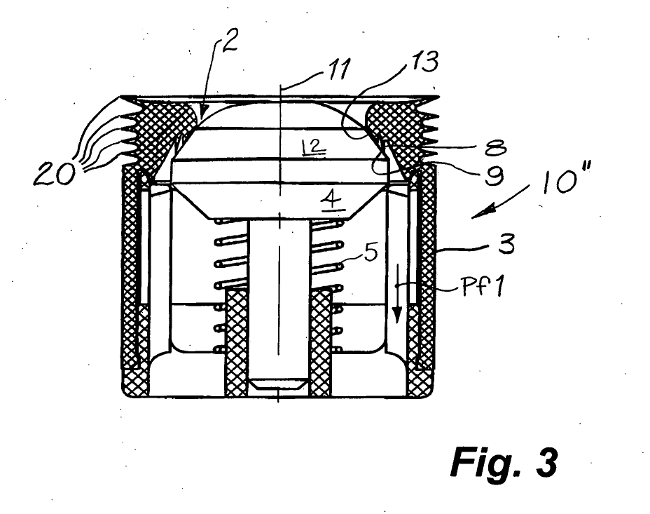

Referring to FIG. 3, another embodiment of a check valve 10″ is shown which includes the valve 2 having the sealing lip 8 in accordance with FIG. 1 formed integrally on the inner peripheral surface of the outer housing 3. The stop 13 is also provided which contacts the inclined surface 12 of the closing part 4 in the closed position of the check valve 10″, providing an additional seal in this region of the check valve 10″. Additionally, integral lip seals 20, as discussed above in connection with FIG. 2, are integrally formed on the outer circumference of the outer housing 3 in order to seal the check valve 10″ to an inner peripheral surface of a fluid line near the in-flow end of the check valve 10″. This configuration also advantageously eliminates the need for O-ring seals in the check valve 10″, with both the integral inner peripheral sealing lip 8 and the integral outer lip seals being formed in one piece with the housing 3.

Here, it is understood that especially for an integratable part configured as a check valve, the seals 20, 21 can be formed on the outer housing and/or the seals described here can be provided on the valve 2. In as much as it relates to the seals 20, 21 formed on the outer housing 3, these can be provided not only on a check valve, but also on a flow-rate regulator, a jet regulator, or another integratable sanitary part, which can be inserted with its outer housing 3 into a sanitary water or fluid line.

1. Integratable sanitary part (10″) comprising a check valve (2) having an outer housing (3), which can be inserted into a fluid line, the outer housing includes on an outer circumference thereof at least one peripheral seal (20) which seals the outer housing (3) and the fluid line with each other, the at least one seal (20) is integrally formed with the outer housing as a single piece, the check valve including a closing part (4) that is moveable in the outer housing (3) by a restoring force against a flow-through direction (Pf1) against a valve seat (6), an inner surface of the outer housing (3) includes at least one peripheral sealing lip (8) formed from the same material and as an integral piece with the outer housing, the sealing lip (8) projects with a free lip end such that in a closed position of the check valve (10), the lip end forms a seal on the closing part (4).

2. Integratable part according to claim 11, wherein the at least one seal (20) is configured as a lip seal.

3. Integratable part according to claim 2, wherein a plurality of the lip seals (20) are formed as integral pieces on the outer housing (3).

4. Integratable part according to claim 1, wherein the at least one seal (20) is provided in a supply end region of the outer housing (3).

5. Integratable part according to claim 1, wherein the at least one sealing lip (8) forms a peripheral, linear seal on the closing part (4) in the closed position of the check valve (10″) with the free lip end.

6. Integratable part according to claim 1, wherein the at least one sealing lip (8) extends into a conical point in cross section at the free lip end.

7. Integratable part according to claim 1, wherein the at least one sealing lip (8) is oriented with an axis defined by a longitudinal extent thereof approximately parallel to a longitudinal axis (11) of the check valve (10″).

8. Integratable part according to claim 1, wherein a partial region (12) of the closing part (4) contacted by the sealing lip is configured as an inclined surface oriented in the flow-through direction (Pf1) from inside to outside.

9. Integratable part according to claim 1, wherein the check valve (10) has at least one stop (13) for the closing part (4), which is engaged in the closed position.

10. Integratable part according to claim 9, wherein an annular, peripheral partial region of the inner surface of the outer housing (3) is provided as the stop (13).

11. Integratable part according to claim 9, wherein the at least one stop contacts an inclined surface (12) of the closing part (4).

12. Integratable part according to claim 7, wherein the inner surface of the outer housing (3) is formed in an annular, peripheral partial region acting as a stop (13) complementary to an opposite partial region (12) of the closing part (8) in the closed position.

13. Integratable part according to claim 12, wherein the at least one sealing lip (8) and the at least one stop (13) are arranged so that the sealing lip (8) contacts the closing part (4) before the stop (13) is engaged.

14. Integratable part according to claim 6, wherein the at least one sealing lip (8) is configured to be flexible and elastic at least in a region of the free lip end.

15. Integratable part according to claim 6, wherein a return flow acts on the at least one sealing lip (8), which can be pressed against the closing part (4).

16. Integratable part according to claim 1, wherein the outer housing (3) and the closing part (4) are produced from the same material.
